(19) United States
(12) Patent Application Publication
(10) Pub. No.: US 2009/0205464 A1
(43) Pub. Date: Aug. 20, 2009

(54) Starter including one-way clutch and method of manufacturing clutch outer of one-way clutch

(75) Inventors: Hiroki Takeuchi, Anjo-shi (JP); Hidetaka Banno, Anjo-shi (JP)

Correspondence Address: OLIFF & BERRIDGE, PLC, P.O. BOX 320850, ALEXANDRIA, VA, 22320-4850, US

(73) Assignee: DENSO CORPORATION, Kariya-City (JP)

(21) Appl. No.: 12/318,993

(22) Filed: Jan. 14, 2009

(30) Foreign Application Priority Data
Feb. 14, 2008 (JP) 2008-033047

(51) Int. Cl. F02N 15/02; B21D 22/00

(52) U.S. Cl. 74/7 C; 72/356

(57) ABSTRACT

The starter includes a planetary type reduction gear device for reducing rotational speed of a motor, the planetary type reduction gear including a sun gear coupled to a shaft of the motor, planetary gears engaging with the sun gear and a planetary carrier outputting a revolutional motion around the sun gear of the planetary gears as a drive torque of the motor. The starter further includes a one-way clutch transmitting the drive torque from a side of a clutch outer thereof to a side of a clutch inner thereof through rollers disposed in cam chambers formed between the clutch outer and the clutch inner. The clutch outer is integral with the planetary carrier. The planetary carrier is integrally formed with planetary shafts rotatably supporting the planetary gears, and projecting pins projecting in the same direction as the planetary shafts. The planetary shafts are located inwardly of the cam chambers.

### CROSS-REFERENCE TO RELATED APPLICATION

This application is related to Japanese Patent Application No. 2008-33047 filed on Feb. 14, 2008, the contents of which are hereby incorporated by reference.

### BACKGROUND OF THE INVENTION

1. Field of the Invention

The present invention relates to a starter including a planetary gear type reduction gear device and a one-way clutch, and a method of manufacturing a clutch outer of the one-way clutch.

2. Description of Related Art

There is known a starter including a planetary gear type reduction gear device and a one-way clutch, and having a structure in which planetary shafts rotatably supporting planetary gears are disposed integrally with a planetary carrier, and the planetary carrier is integrated with a clutch outer of the one-way clutch. To manufacture such a clutch outer with ease, it is known to use a cold forging process. However, the cold forging process has a problem that, since the cross-sectional area of the planetary shafts is small compared to that of the clutch outer, a pressing force of a cam punch used to press a raw forging material becomes large. This may cause a mold used in the cold forging process to be applied with stress large enough to damage the mold. As a technique to cope with this problem, it is known to integrate, in addition to the planetary shafts, projecting pins projecting in the same direction as the planetary shafts with the planetary carrier. For example, refer to Japanese Patent Application Laid-open No. 2004-301049.

However, the above technique has a problem in that since the planetary shafts and the projecting pins are disposed outside cam chambers formed in the clutch outer, fluidity of the raw material to the planetary shaft and the projecting pins is lowered when the raw material is pressed by the cam punch to form the cam chambers. That is, since it becomes difficult for the raw material to flow into the holes made in the mold for forming the planetary shafts and the projecting pins, the shaft diameter of the planetary shafts may become non-uniform, and cracks may occur in the outer peripheral surface of the planetary shafts.

### SUMMARY OF THE INVENTION

The present invention provides a starter comprising:

a planetary type reduction gear device for reducing rotational speed of a motor, the planetary type reduction gear including a sun gear coupled to a shaft of the motor, planetary gears engaging with the sun gear and a planetary carrier outputting a revolutional motion around the sun gear of the planetary gears as a drive torque of the motor; and

a one-way clutch transmitting the drive torque from a side of a clutch outer thereof to a side of a clutch inner thereof through rollers disposed in cam chambers formed between the clutch outer and the clutch inner;

the clutch outer being integral with the planetary carrier,

the planetary carrier being integrally formed with planetary shafts rotatably supporting the planetary gears, and projecting pins projecting in the same direction as the planetary shafts,

the planetary shafts being located inwardly of the cam chambers.

The present invention also provides a method of manufacturing the clutch outer as described above by use of a cam punch for forming the cam chambers, a concave die for defining a radially outer peripheral of the clutch outer and an axial end surface of the planetary carrier, the concave die being formed with holes for forming the planetary shafts and holes for defining the projecting pins, and knockout pins inserted into the holes for forming the planetary shafts to define axial end surfaces of the planetary shafts,

the method comprising the steps of:

setting a raw material in the die; and

molding the raw material by pressing the raw material by the cam punch, while pressurizing the knockout pins.

The present invention also provides a method of manufacturing the clutch outer as described above by use of a cam punch for forming the cam chambers, a concave die for defining a radially outer peripheral of the clutch outer and an axial end surface of the planetary carrier, the concave die being formed with holes for forming the planetary shafts and holes for defining the projecting pins, knockout pins inserted into the holes for forming the planetary shafts to define axial end surfaces of the planetary shafts, and an outer punch located around periphery of the cam punch, the method comprising the steps of:

setting a raw material in the die; and

molding the raw material by pressing the raw material by the cam punch, while pressurizing the outer punch and the knockout pins.

The present invention also provides a method of manufacturing a clutch outer of a one-way clutch included in a starter by a cold forging process, the starter including:

a planetary type reduction gear device for reducing rotational speed of a motor, the planetary type reduction gear including a sun gear coupled to a shaft of the motor, planetary gears engaging with the sun gear and a planetary carrier outputting a revolutional motion around the sun gear of the planetary gears as a drive torque of the motor; and

a one-way clutch transmitting the drive torque from a side of a clutch outer thereof to a side of a clutch inner thereof through rollers disposed in cam chambers formed between the clutch outer and the clutch inner;

the clutch outer being integral with the planetary carrier,

the planetary carrier being integrally formed with planetary shafts rotatably supporting the planetary gears, the planetary carrier having a round hole formed at a radially center portion thereof,

the method comprising the steps of:

forming the planetary shafts inwardly of the cam chambers;

forming a projecting pin in a radially center portion of the planetary carrier, the projecting pin projecting in the same direction as the planetary shafts; and

forming the round hole to remove the projecting pin.

According to the present invention, it is possible to provide a starter in which planetary shafts integrally formed with a planetary carrier thereof have no cracks, and to provide a method of manufacturing a clutch outer integral with the planetary carrier of the starter in which the planetary shafts are uniform in diameter.

Other advantages and features of the invention will become apparent from the following description including the drawings and claims.

### BRIEF DESCRIPTION OF THE DRAWINGS

In the accompanying drawings:

FIG. 1 is a cross-sectional view of a starter of an embodiment of the invention;

FIG. 2A is an axial front view of an clutch outer of a one-way clutch included in the starter of the embodiment of the invention;

FIG. 2B is a cross-sectional view of the clutch outer taken along the line A-A in FIG. 2A;

FIG. 3 is a diagram showing a structure of a manufacturing apparatus for manufacturing the clutch outer shown in FIGS. 2A and 2B;

FIG. 4 is a cross-sectional view of a mold of the manufacturing apparatus in which a raw material is set;

FIG. 5 is a cross-sectional view of the mold during a molding process;

FIG. 6 is a cross-sectional view of the mold during the molding process; and

FIG. 7 is a cross-sectional view of the mold after completion of the molding process.

### PREFERRED EMBODIMENTS OF THE INVENTION

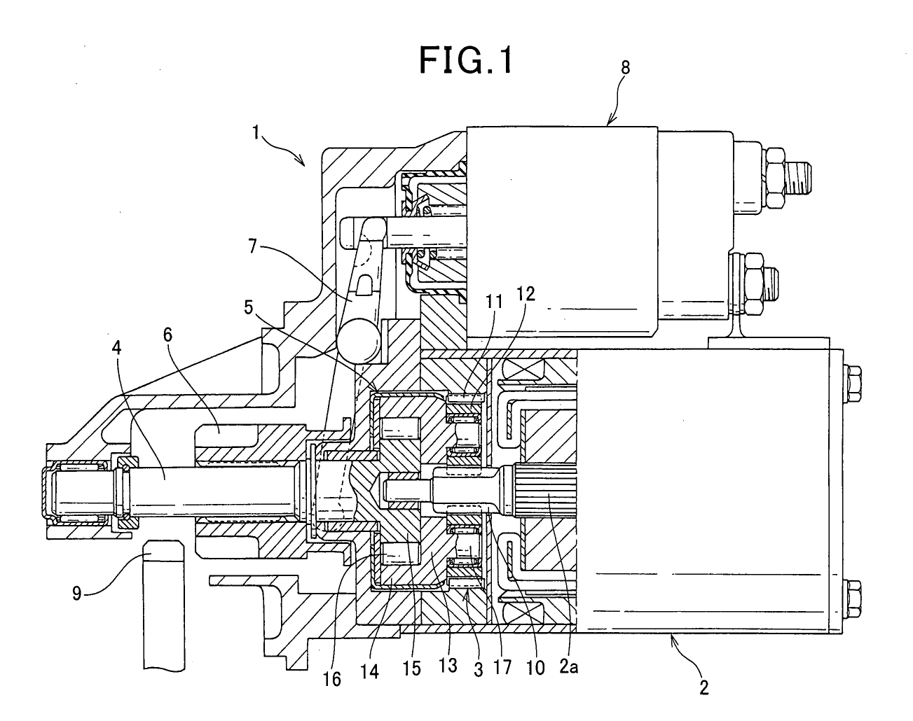

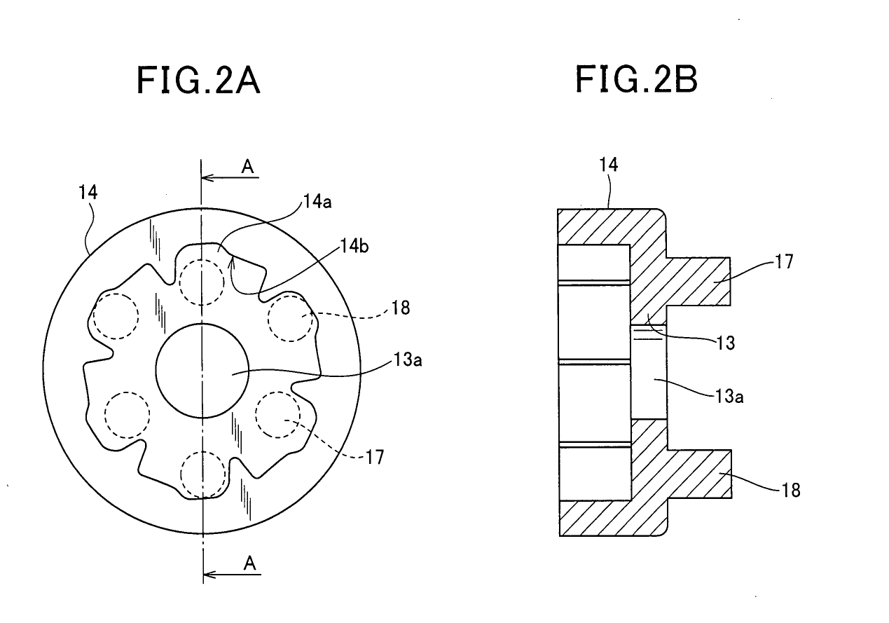

FIG. 1 is a cross-sectional view of a starter 1 according to an embodiment of the invention, FIG. 2A is an axial front view of a clutch outer 14 of a one-way clutch included in the starter 1, and FIG. 2B is a cross-sectional view of the clutch outer 14 taken along the line A-A line in FIG. 2A. As shown in FIG. 1, the starter 1 includes a motor 2 generating a torque, a reduction gear device 3 for reducing the rotation of the motor 2, an output shaft 4 disposed coaxially with an armature shaft 2a of the motor 2, a one-way clutch 5 transmitting the rotation of the motor 2 reduced by the reduction gear device 3 to the output shaft 4, a pinion gear 6 coupled to the outer periphery of the output shaft 4 by a helical spline, and an electromagnetic switch 8 which opens and closes a main contact of a motor circuit (not shown), and causes the pinion gear 6 to move in the direction opposite to the motor 2 through a shift lever 7. The starter 1 operates to start an engine (not shown) by transmitting the torque generated by the motor 2 to a ring gear 9 of the engine through the pinion gear 6.

Next, the reduction gear device 3 and the one-way clutch 5 are explained in detail below. The reduction gear device 3, which is a planetary gear type reduction gear device disposed coaxially with the armature shaft 2a of the motor 2, includes a sun gear 10 formed in one end of the armature shaft 2a, an annular internal gear 11 concentrically disposed with the sun gear 10, a plurality of planetary gears 12 engaging with the sun gear 10 and the internal gear 11, and a planetary carrier 13 outputting the revolutional motion of the planetary gears 12. The one-way clutch 5 includes the clutch outer 14 having an inner periphery along which cam chambers 14a are formed (see FIGS. 2A and 2B), a clutch inner 15 rotatably disposed radially inwardly of the clutch inner 14, rollers 16 disposed on the outer periphery of the clutch inner 15 so as to be located in the cam chambers 14a, and springs (not shown) for applying biasing force to the rollers 16.

The planetary carrier 13, which is integral with the planetary carrier 13, is integrally provided with three planetary shafts 17 rotatably supporting the planetary gears 12, and three projecting pins 18 projecting in the same direction as the planetary shafts 17 as shown in FIG. 2B. The planetary carrier 13 is formed with a round hole 13a at a radially center portion thereof. The planetary shafts 17 and the projecting pins 18 are disposed inwardly of the cam chambers 14a as shown in FIG. 2A. it is a matter of course that the projecting pins 18 are located in such positions as not to interfere with the planetary gears 12 supported by the planetary shafts 17. Here, the phrase “inwardly of the cam chambers 14a” means “inwardly of cam walls 14b constituting the outer peripheries of the cam chambers 14 (see FIG. 2B)”, that is, within regions in which the axial thickness is formed thin by being pressed by a below described cam punch 19 during manufacture of the clutch outer 14.

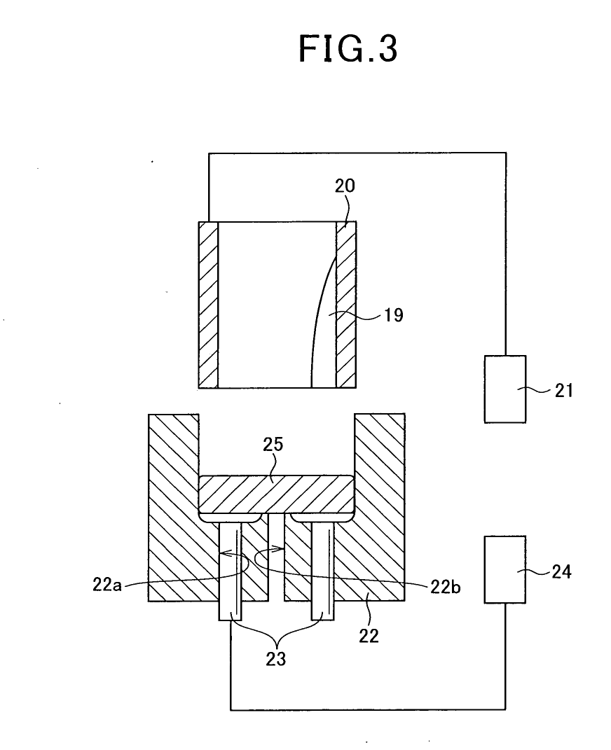

Next, a method of manufacturing the clutch outer 14 is explained. The clutch outer 14 is manufactured by a cold forging process using a below described manufacturing apparatus. As shown in FIG. 3, the manufacturing apparatus includes a mold constituted by the cam punch 19 for forming the cam chambers 14a, an outer punch 20 located around periphery of the cam punch 19, a concave die 22 for defining the radially outer peripheral of the clutch outer 14 and an end surface of the planetary carrier 13, the concave die 22 being formed with holes 22a and 22b, and knockout pins 23 inserted into the holes 22a. The manufacturing apparatus further includes a pressure generating device 21 for pressurizing the outer punch 20, and a pressure generating device 24 for pressurizing the knockout pins 23.

The outer punch 20 serves to define an axial end surface of the clutch outer 14 when the raw material 25 set in the die 22 is pressed by the cam punch 19. The knockout pins 23 serve to define an axial end surface of each of the planetary shafts 17 and the projecting pins 18 when the raw material 25 set in the die 22 is pressed by the cam punch 19. The holes 22a are formed at six positions corresponding to the three planetary shafts 17 and the three projecting pins 18 shown in FIG. 2A. On the other hand, the hole 22b is formed at one position to form one projecting pin 18 at a radially center portion of the planetary carrier 13 other than the above three projecting pins 18.

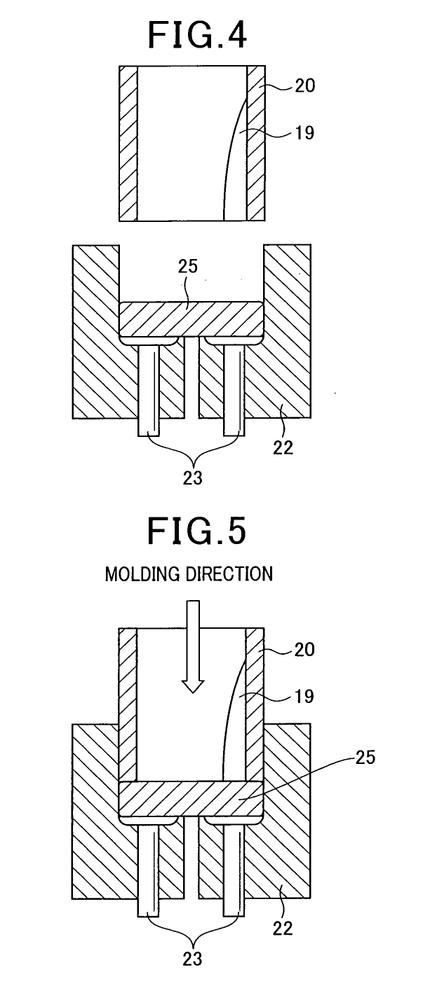

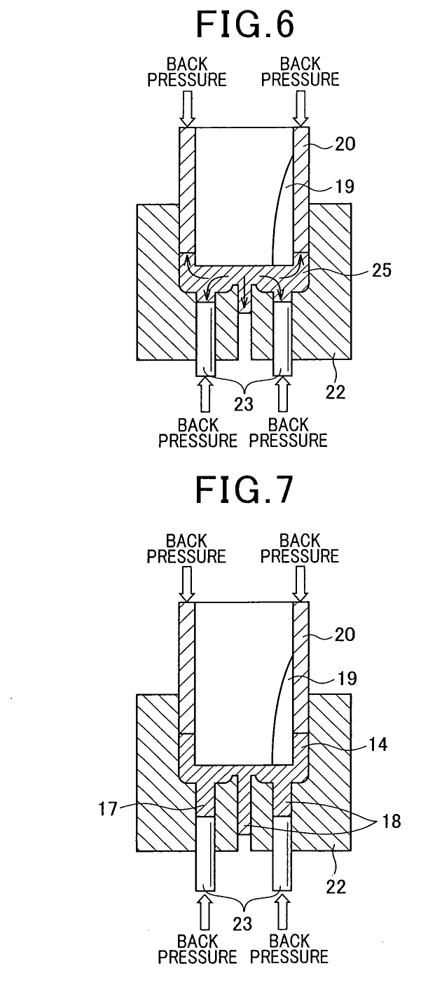

The clutch outer 14 is manufactured by performing the steps shown in the flowchart of FIG. 8. First, as shown in FIG. 4, a raw material 25 is set within the die 22 (step S10). Next, as shown in FIG. 5, the cam punch 19 and the outer punch 20 are descended until they abut on the surface of the raw material 25 (step S20). Thereafter, the raw material 25 is pressed toward the die 22 by the cam punch 19 with the outer punch 20 and the knockout pin 23 being applied with back pressure by the pressure generating devices 21 and 24 (step S30). As a result, as shown by the arrows in FIG. 6, the raw material flows to the outside of the cam punch 19 and into the holes 22a and 22b. Subsequently, by descending the cam punch 19 by a predetermined stroke to press the raw material 25 with the outer punch 20 and the knockout punch 23 being applied with the back pressure as shown in FIG. 7, the clutch outer 14 including the planetary shafts 17 and the projecting pins 18 is obtained (step S40). Finally, the round hole 13a is formed in the radially center portion of the planetary carrier 13 to remove one of the projecting pins 18 which is located in the radially center portion (step S50).

The above embodiment of the invention provides the following advantages. The clutch outer 14 manufactured by the above described process includes the projecting pins 18 integrally formed thereto in addition to the planetary shafts 17. Accordingly, since the cross sectional area of a passage through which the raw material flows increases, the pressing force of the cam punch 19 can be reduced. This makes it possible to increase the life of the mold, because the stress applied to the mold can be reduced. Since the planetary shafts 17 and the projecting pins 18 are located inwardly of the cam chambers 14a, it is possible to apply a uniform load to the cross-sectional area in the radial direction of each of the planetary shafts 17 and the projecting pins 18 so that the raw material flows uniformly. Furthermore, by pressurizing the outer punch 20 and the knockout pins 23 during the molding process, the raw material fillability to the planetary shafts 17 and the projecting pins 18 can be improved. Hence, according to this embodiment, it is possible to form the planetary shafts 17 and the projecting pins 18 which are uniform in diameter, and do not have cracks.

It is a matter of course that various modifications can be made to the above embodiment as described below.

In the above embodiment, the outer punch 20 and the knockout pins 23 are pressurized when the raw material 25 is pressed by the cam punch 19. The back pressures applied to the outer punch 20 and the knockout pins 23 may be varied continuously over time, or in stages. For example, during the early stage of the molding process, the back pressure may be set to a larger value to generate a larger molding load in order for the cross section of each of the planetary shafts 17 and the projecting pins 18 to be a perfect circle, and during the medium stage of the molding process, the back pressure may be set to a smaller value to generate a smaller molding load in order for the planetary shafts 17 and the projecting pins 18 to extend sufficiently. During the final stage of the molding process, the back pressure is set to a larger value again to generate a larger molding load in order to remove shear droop or sink marks. According to this modification, it is possible to improve the shape accuracy and height accuracy of the planetary shafts 17 and the projecting pins 18. In addition, by reducing the back pressure during the medium stage of the molding process, it is possible to lengthen the planetary shafts 17 and the projecting pins 18, and to increase the life of the mold because the pressing force applied to the mold becomes smaller. In the above embodiment, although the projecting pins 18 are located inwardly of the cam chambers 14a together with the planetary shafts 17, the above embodiment may be so modified that only the planetary shafts 17 are located inwardly of the cam chambers 14a, and the projecting pins 18 are located outwardly of the cam chambers 14a.

The above explained preferred embodiments are exemplary of the invention of the present application which is described solely by the claims appended below. It should be understood that modifications of the preferred embodiments may be made as would occur to one of skill in the art.

What is claimed is:

1. A starter comprising:
a planetary type reduction gear device for reducing rotational speed of a motor, said planetary type reduction gear including a sun gear coupled to a shaft of said motor, planetary gears engaging with said sun gear and a planetary carrier outputting a revolutional motion around said sun gear of said planetary gears as a drive torque of said motor; and
a one-way clutch transmitting said drive torque from a side of a clutch outer thereof to a side of a clutch inner thereof through rollers disposed in cam chambers formed between said clutch outer and said clutch inner;
said clutch outer being integral with said planetary carrier,
said planetary carrier being integrally formed with planetary shafts rotatably supporting said planetary gears, and projecting pins projecting in the same direction as said planetary shafts,
said planetary shafts being located inwardly of said cam chambers.

2. A method of manufacturing said clutch outer as described in claim 1 by use of a cam punch for forming said cam chambers, a concave die for defining a radially outer peripheral of said clutch outer and an axial end surface of said planetary carrier, said concave die being formed with holes for forming said planetary shafts and holes for defining said projecting pins, and knockout pins inserted into said holes for forming said planetary shafts to define axial end surfaces of said planetary shafts,
said method comprising the steps of:
setting a raw material in said die; and
molding said raw material by pressing said raw material by said cam punch, while pressurizing said knockout pins.

3. The method according to claim 2, wherein pressure applied to said knockout pins is varied during said molding step.

4. A method of manufacturing said clutch outer as described in claim 1 by use of a cam punch for forming said cam chambers, a concave die for defining a radially outer peripheral of said clutch outer and an axial end surface of said planetary carrier, said concave die being formed with holes for forming said planetary shafts and holes for defining said projecting pins, knockout pins inserted into said holes for forming said planetary shafts to define axial end surfaces of said planetary shafts, and an outer punch located around periphery of said cam punch,
said method comprising the steps of:
setting a raw material in said die; and
molding said raw material by pressing said raw material by said cam punch, while pressurizing said outer punch and said knockout pins.

5. The method according to claim 4, wherein pressures applied to said outer punch and said knockout pins are varied during said molding step.

6. A method of manufacturing a clutch outer of a one-way clutch included in a starter by a cold forging process, said starter including:
a planetary type reduction gear device for reducing rotational speed of a motor, said planetary type reduction gear including a sun gear coupled to a shaft of said motor, planetary gears engaging with said sun gear and a planetary carrier outputting a revolutional motion around said sun gear of said planetary gears as a drive torque of said motor; and
a one-way clutch transmitting said drive torque from a side of a clutch outer thereof to a side of a clutch inner thereof through rollers disposed in cam chambers formed between said clutch outer and said clutch inner;
said clutch outer being integral with said planetary carrier,
said planetary carrier being integrally formed with planetary shafts rotatably supporting said planetary gears,
said planetary carrier having a round hole formed at a radially center portion thereof,
said method comprising the steps of:
forming said planetary shafts inwardly of said cam chambers;
forming a projecting pin in a radially center portion of said planetary carrier, said projecting pin projecting in the same direction as said planetary shafts; and
forming said round hole to remove said projecting pin.
